(19) United States
(12) Patent Application Publication
(10) Pub. No.: US 2018/0122581 A1
(43) Pub. Date: May 3, 2018

(54) SOLID ELECTROLYTIC CAPACITOR

(71) Applicant: TOKIN Corporation, Sendai-shi (JP)

(72) Inventors: Hiroki SATO, Sendai-shi (JP); Takeo KASUGA, Sendai-shi (JP)

(21) Appl. No.: 15/783,140

(22) Filed: Oct. 13, 2017

(30) Foreign Application Priority Data
Oct. 27, 2016 (JP) 2016-210641

(51) Int. Cl. H01G 9/028; H01G 9/15; H01G 9/052; H01G 9/00

(52) U.S. Cl. CPC H01G 9/028; H01G 9/0003; H01G 9/0525; H01G 9/15

(57) ABSTRACT

A solid electrolytic capacitor whose electrolyte is less susceptible to deterioration due to a high temperature and which has a low ESR is provided. A solid electrolytic capacitor (1) includes a capacitor element (10) including an anode conductor (11), a dielectric layer (12), a solid electrolytic layer (13), and a cathode extraction layer (14), the dielectric layer (12), the solid electrolytic layer (13), and the cathode extraction layer (14) being successively formed on the anode conductor (11). The solid electrolyte layer (13) includes a graphene-containing layer including at least one type of a graphene structure consisting of a graphene or a multi-layer graphene, and the graphene or the multi-layer graphene may include a modifying group.

### INCORPORATION BY REFERENCE

This application is based upon and claims the benefit of priority from Japanese patent application No. 2016-210641, filed on Oct. 27, 2016, the disclosure of which is incorporated herein in its entirety by reference.

### BACKGROUND

The present disclosure relates to a solid electrolytic capacitor.

An electrolytic capacitor includes a capacitor element including an anode conductor, a dielectric layer, a solid electrolytic layer, and a cathode extraction layer, in which the dielectric layer, the solid electrolytic layer, and the cathode extraction layer are successively formed on the anode conductor. The form of the electrolyte of such an electrolytic capacitor (hereinafter also referred to as a “capacitor electrolyte”) is a liquid, a solid, or the like. Examples of the liquid electrolyte include an electrolytic solution obtained by dissolving an organic electrolyte such as adipic acid, sebacic acid, boric acid, phosphoric acid, and a salt of them in a low-molecular-weight organic solvent such as ethylene glycol and γ-butyrolactone. Examples of the solid electrolyte include: organic conductive polymers such as polythiophene, polypyrrole, polyaniline, and a derivative of them; and inorganic semiconductors such as manganese dioxide.

Japanese Unexamined Patent Application Publication No. 2015-195313 (hereinafter called “Patent Literature 1”) discloses an electrolytic capacitor including an anode body; a dielectric layer formed on the anode body; a solid electrolyte layer covering at least a part of the dielectric layer; and a cathode layer opposed to the solid electrolyte layer, in which: the cathode layer includes a carbon layer covering at least a part of the solid electrolyte layer, and a metal paste layer including metal particles and a resin; and the carbon layer includes a graphene layer including graphene pieces (claim 1). Patent Literature 1 mentions that examples of the solid electrolyte include manganese dioxide, a conductive polymer, and a TCNQ complex salt, and among them, the conductive polymer is preferred.

International Patent Publication No. WO2014/046216 (hereinafter called “Patent Literature 2”) discloses a solid electrolytic capacitor in which: a dielectric oxide film layer, a solid electrolyte layer, a conductive carbon layer, and a cathode extraction layer are successively formed on a surface of an anode body made of a metal material; and the conductive carbon layer contains a graphene and/or a nano-graphene (claim 1). Patent Literature 2 mentions a conductive polymer as being the solid electrolyte.

### SUMMARY

In some cases, an electrolytic capacitor is exposed to a high-temperature environment when it is used in an in-vehicle state or the like. Therefore, it is desirable that an electrolytic capacitor has a high heat resistance. However, an electrolyte solution including an organic electrolyte and an organic solid electrolyte made of a conductive polymer or the like evaporate or decompose under a high-temperature environment, thus possibly leading to deterioration in electric characteristics such as an equivalent series resistance (hereinafter also simply expressed as “ESR”). Although an inorganic solid electrolyte such as manganese dioxide has a high heat-resistance, its conductivity is relatively low compared to that of the aforementioned organic electrolyte. Therefore, a capacitor using the inorganic solid electrolyte tends to have a relatively high ESR and hence have poor electric characteristics. As described above, in related-art capacitor electrolytes, the heat-resistance and the conductivity are tradeoff characteristics. Therefore, it is difficult to achieve both of these characteristics at the same time.

The present disclosure has been made in view of the above-described circumstance and an object thereof is to provide a solid electrolytic capacitor whose electrolyte is less susceptible to deterioration due to a high temperature and which has a low ESR.

The inventor of the present disclosure has found that the above-described problem can be solved by using at least one type of a graphene structure as a capacitor electrolyte, and thereby completed the present disclosure.

A solid electrolytic capacitor according to the present disclosure includes a capacitor element including an anode conductor, a dielectric layer, a solid electrolytic layer, and a cathode extraction layer, the dielectric layer, the solid electrolytic layer, and the cathode extraction layer being successively formed on the anode conductor, in which,

the solid electrolyte layer includes a graphene-containing layer including at least one type of a graphene structure consisting of a graphene or a multi-layer graphene, and the graphene or the multi-layer graphene may include a modifying group.

According to the present disclosure, it is possible to provide a solid electrolytic capacitor whose electrolyte is less susceptible to deterioration due to a high temperature and which has a low ESR.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF DRAWINGS

FIG. 1 is a schematic cross section of a main part of a solid electrolytic capacitor according to an embodiment of the present disclosure.

### DESCRIPTION OF EMBODIMENTS

[Solid Electrolytic Capacitor]

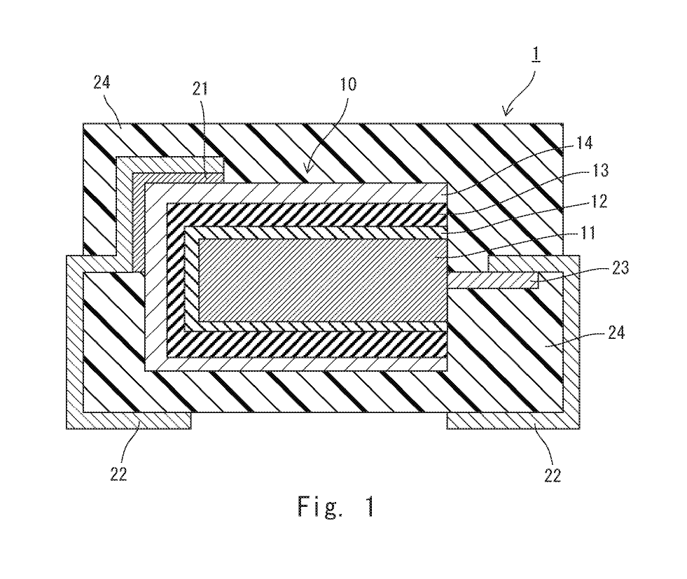

A solid electrolytic capacitor according to an embodiment in accordance with the present disclosure is explained with reference to the drawing. FIG. 1 is a schematic cross section of a main part of a solid electrolytic capacitor.

As shown in the figure, a solid electrolytic capacitor 1 includes a capacitor element 10 including an anode conductor 11, a dielectric layer 12, a solid electrolytic layer 13, and a cathode extraction layer 14, in which the dielectric layer 12, the solid electrolytic layer 13, and the cathode extraction layer 14 are successively formed on the anode conductor 11. Note that the solid electrolytic layer 13 covers at least a part of the dielectric layer 12 and the cathode extraction layer 14 covers at least a part of the solid electrolytic layer 13.

In the solid electrolytic capacitor 1 according to this embodiment, the solid electrolytic layer 13 includes at least one graphene-containing layer consisting of at least one type of a graphene structure consisting of a graphene or a multi-layer graphene. Note that the graphene or the multi-layer graphene may include a modifying group.

The rest of the basic structure of the solid electrolytic capacitor 1 is similar to that of a related-art publicly-known solid electrolytic capacitor. Further, for the overall structure of the capacitor, and the shape, the material, and the like of each component, publicly-known ones can be adopted. That is, there is no particular restriction on them. In the figure, a reference number 21 indicates a conductive adhesive layer and a reference number 22 indicates electrodes. Further, a reference number 23 indicates a metal lead made of a valve-action metal and a reference number 24 indicates a packaging resin.

At least one of the surface-layer parts of the anode conductor 11 includes at least one type of a valve-action metal. There is no particular restriction on the valve-action metal, provided that it develops a rectifying effect between the dielectric layer 12 and the electrolyte. Examples of the valve-action metal include aluminum, tantalum, niobium, titanium, zirconium, hafnium, tungsten, and alloys of them. There is no particular restriction on the form of the anode conductor 11 and examples of the form include a powder-sintered body, an etching foil, and a vapor-deposition film.

There is no particular restriction on the dielectric layer 12 and examples thereof include a dielectric oxide film (an anode oxide film) that is formed by anode-oxidizing the surface-layer part including the valve-action metal of the anode conductor 11.

There is no particular restriction on the cathode extraction layer 14, provided that it electrically connects the solid electrolytic layer 13 with an electrode (which will be described later). However, a metal-containing layer including a metal such as silver, copper, and aluminum is preferred. In an aspect, the metal-containing layer can be formed by using a metal paste that includes metal particles, a resin, and, if necessary, a dispersion medium. Examples of the metal particles include silver particles, copper particles, and aluminum particles. Among them, silver particles are preferred because of their low electric resistance. Examples of the resin include a thermosetting resin and a thermoplastic resin. The dispersion medium is dried and removed by using a publicly-known method.

In the solid electrolytic capacitor 1, an electrode 22 is attached to the cathode extraction layer 14 of the capacitor element 10. In an aspect, the electrode 22 is formed by bending a belt-like metal plate or the like and preferably mechanically and electrically connected to the cathode extraction layer 14 by using a conductive adhesive layer 21. As for the material for the conductive adhesive layer 21, examples include a metal paste that includes metal particles, a resin, and, if necessary, a dispersion medium. The metal particles and the resin used in the metal paste may be similar to those of the meal paste mentioned in the explanation of the cathode extraction layer 14.

As described above, in the solid electrolytic capacitor 1 according to this embodiment, the solid electrolytic layer 13 includes a graphene-containing layer including at least one type of a graphene structure.

The capacitor electrolyte needs to develop a rectifying effect for accumulation of electricity between the capacitor electrolyte and the dielectric layer 12 (preferably a dielectric oxide film). The inventor of the present disclosure has found that when a solid electrolytic layer 13 including a graphene-containing layer including at least one type of a graphene structure is actually formed on the dielectric layer 12, a rectifying effect is developed and hence a capacitor performance is developed.

The “graphene” is a carbon-atom sheet in which a plurality of carbon atoms form an sp2-coupling with a thickness equivalent to the thickness of one carbon atom and thereby form a two-dimensional hexagonal lattice structure.

The “graphene structure” consists of a graphene consisting of the above-described carbon-atom sheet having the single layer structure, or consists of a laminate in which a plurality of graphenes each consisting of the above-described carbon-atom sheet having the single layer structure are laminated by a Van der Waals force. The graphene structure may include a modifying group. The graphene structure may be one that has been subjected to a doping process or the like.

The graphene structure having the above-described structure exhibits unique characteristics that are not exhibited by other carbon materials, and develops high electron mobility, a high thermal conductivity, and a high mechanical strength. The graphene structure has such a tendency that the smaller the number of its layers is, the more its electron mobility, thermal conductivity, and mechanical strength improve. Since the graphene structure is a material having a high conductivity and a high thermal resistance as described above, it is possible to provide a solid electrolytic capacitor 1 which is less susceptible to deterioration due to a high temperature and has a low ESR by using at least one type of a graphene structure as its solid electrolyte.

To effectively develop the above-described characteristics (such as a high conductivity) of the graphene structure, the number of layers of the graphene structure is preferably 1 to 35, more preferably 1 to 30, particularly preferably 1 to 20, and most preferably 1 to 15.

Graphite has a structure in which a large number of graphenes each consisting of the above-described carbon-atom sheet having the single layer structure are laminated, and the number of layers thereof is at least 40 and usually at least 100. Unlike the graphene structure having the above-specified number of layers, amorphous carbon such as graphite and carbon black does not have excellent electron mobility/thermal conductivity/mechanical strength. Therefore, in this specification, it is assumed that “a carbon material including a graphene structure” does not include amorphous carbon such as graphite and carbon black, unless otherwise specified.

In this specification, “the number of layers of a graphene structure” indicates an average value of the numbers of layers of 20 randomly-selected graphene structures, unless otherwise specified. Note that the number of layers of a graphene structure can be identified (i.e., determined) by an atomic force microscope (AFM), Raman spectroscopy, an observation on a silicon substrate by an optical microscope, or the like.

For example, a Raman spectroscopic spectrum of a graphene structure having 1 to 35 layers differs from those of other carbon materials, such as graphite, consisting of a graphene structure having at least 40 layers. The graphene structure having 1 to 35 layers has a peak (called a G-band) originating in an sp2 coupling near 1,600 cm⁻¹ and a peak (called a 2D-band) originating in an sp3 coupling near 2,700 cm⁻¹. It is believed that a ratio between the strengths of these peaks ((sp2 peak strength)/(sp3 peak strength)) of a graphene structure has a correlation with the number of layers of that graphene structure.

In an aspect, a graphene structure has a thin-flat shape. In this case, there is no restriction on the maximum length of the graphene structure in a surface direction of the carbon sheet. However, the maximum length of the graphene structure is preferably 0.1 to 100 μm and more preferably 0.5 to 50 μm. The thickness of the graphene structure is preferably 1 to 10 nm and more preferably 1 to 5 nm. In this specification, “the thickness and the maximum length of a graphene structure” indicate average values of the thicknesses and the maximum lengths of 20 graphene structures, unless otherwise specified.

As the graphene structure, a graphene structure consisting of carbon atoms alone may be used or a modified graphene structure that is obtained by adding various types of functional groups in a graphene structure consisting of carbon atoms alone may be used. Examples of a modifying group for the modified graphene structure include oxygen-containing groups such as a carbonyl group, a hydroxyl group, a carboxy group, and a sulfo group. By adding such an oxygen-containing group in a graphene structure, the graphene structure can be made soluble in a polar solvent such as water, thus making it possible to easily form a graphene-containing layer by a liquid phase method. Further, a function for repairing the dielectric layer 12 is developed and hence a leak current (LC) of the capacitor can be reduced.

There is no particular restriction on the method for forming a graphene-containing layer. Examples of the method include a gas phase method such as a CVD (Chemical Vapor Deposition) method, and a liquid phase method in which a dispersion liquid or a solution of a graphene structure (preferably a modified graphene structure) that is manufactured by a publicly-known method is deposited on the dielectric layer 12 and dried.

There is no particular restriction on the ingredient used in the gas phase method. Examples of the ingredient include carbon and a carbon-containing compound such as an oxide containing carbon atoms.

Examples of the method for manufacturing a graphene structure used for the liquid phase method include a method for peeling off a single-layer graphene or a multiple-layer graphene from graphite that is used as the ingredient.

There is no particular restriction on the method for modifying a graphene structure. For example, when the modifying group is a carbonyl group, a hydroxyl group, or a carboxy group, a method for performing an oxidation process using an oxidizer such as a solution including sulfuric acid or potassium permanganate may be used. Examples also include a method for, for an arbitrary modifying group, heating a compound including the modifying group to be added together with a catalyst in a solution. When the modifying group is a sulfo group, a method disclosed in Japanese Unexamined Patent Application Publication No. 2015-215188 in which a graphene structure is directly modified may be used. There is no particular restriction on the timing at which a modifying group is added. That is, a modifying group may be added before peeling off a graphene structure from graphite that is used as the ingredient, during the peeling process, or after the peeling process.

When a material having relatively large surface roughness (i.e., projections and depressions) such as a powder-sintered body and an etching foil is used as the anode conductor 11 and a dielectric layer 12 is formed by an anode oxidation method, a dielectric layer 12 having relatively large surface roughness is formed. In such a case, it is necessary to fill microscopic depressions on the surface of the dielectric layer 12 with an electrolyte to draw out a capacity. Therefore, it is preferable to use a liquid phase method in which a laminate of a dielectric layer 12 and an anode conductor 11 is submerged in a dispersion liquid or a solution of a graphene structure (preferably a modified graphene structure).

There is no particular restriction on the condition for forming a graphene-containing layer and the condition can be designed as appropriate according to the formation method. The environmental temperature may be a room temperature or a high temperature. Further, the capacitor element may not be heated or may be heated. The atmosphere may be air or an inert gas atmosphere. Examples of the inert gas include an argon gas, a helium gas, and a nitrogen gas. The pressure may be a reduced pressure, an atmospheric pressure, or an increased pressure.

As described above, a liquid phase method can be adopted by using a modified graphene structure and is preferably adopted. However, if the content of oxygen in the graphene-containing layer is excessively large, there is a possibility that the conductivity decreases and hence the ESR and the LC of the capacitor deteriorate. The content of oxygen in the solid electrolytic layer 13 is preferably no larger than 50 wt. %, more preferably no larger than 40 wt. %, and particularly preferably no larger than 30 wt. %.

When the content of oxygen in the graphene-containing layer, which is formed by using a modified graphene structure, is higher than the above-specified range, it is possible to adjust the content of oxygen (the amount of the modifying group) by reducing an oxidized graphene structure by using a publicly-known reducing agent such as a hydrogen gas, an ammonia gas, and hydrazine. Note that the content of oxygen in the graphene-containing layer can be measured by a public-known ultimate analysis.

Two or more graphene-containing layers may be laminated/formed by combining the above-described methods for forming a graphene-containing layer. For example, a graphene-containing layer may be formed by a liquid phase method. Then, after a reduction process is carried out as required, another graphene-containing layer may be formed by a gas phase method.

Examples of the technique related to the present disclosure include Patent Literatures 1 and 2, which are cited in the “Background” section. Both of these patent literatures use a graphene structure for a cathode extraction layer of a solid electrolytic capacitor. However, Patent Literature 1 mentions only manganese dioxide, a conductive polymer, and a TCNQ complex salt as specific examples of the solid electrolyte. Further, it mentions that among them, the conductive polymer is preferred. Patent Literature 2 mentions only a conductive polymer as a solid electrolyte. Both of the literatures neither disclose nor suggest that a graphene structure is used as a capacitor electrolyte. The use of a graphene structure for a capacitor electrolyte is new knowledge found by the inventor of the present disclosure.

Within the scope that does not depart from the gist of the present disclosure, the graphene-containing layer can include at least one type of an arbitrary component other than the graphene structure.

Examples of the arbitrary component include solid electrolytes other than the graphene. Examples of the other solid electrolyte include: organic conductive polymers such as polythiophene, polyp yrrole, polyaniline, and derivatives of them; and inorganic semiconductors such as manganese dioxide.

Examples of the other arbitrary component include arbitrary resins other than the organic conductive polymers. Examples of the resin other than the organic conductive polymer include polyvinyl alcohol, polyvinyl acetate, polycarbonate, polyacrylate, polymethacrylate, polystyrene, polyurethane, polyacrylonitrile, polybutadiene, polyisoprene, polyether, polyester, polyethylene terephthalate, polybutylene terephthalate, polyamide, polyimide, butyral resins, silicone resins, melamine resins, alkyd resins, cellulose, nitrocellulose, bisphenol A-type epoxy resins, bisphenol F-type epoxy resins, and alicyclic epoxy resins.

Within the scope that does not depart from the gist of the present disclosure, the solid electrolytic layer 13 can include at least one solid electrolyte layer other than the graphene-containing layer. Examples of the solid electrolyte included in the other solid electrolyte layer include: organic conductive polymers such as polythiophene, polypyrrole, polyaniline, and derivatives of them; and inorganic semiconductors such as manganese dioxide. There is no particular restriction on the order of lamination of the at least one graphene-containing layer and the at least one other solid electrolyte layer. However, it is preferred to adopt a structure in which at least a part of the surface of the dielectric layer 12 is in direct contact with the graphene structure.

To obtain a capacitor having a low ESR, the conductivity of the graphene-containing layer is preferably no lower than 1 S/cm, more preferably no lower than 10 S/cm, and particularly preferably no lower than 50 S/cm.

To obtain a capacitor having a low ESR in which the ESR is less susceptible to deterioration due to a high temperature, a ratio of a contact area of the graphene structure to the surface area of the dielectric layer 12 is preferably high. Specifically, the contact area ratio is preferably no lower than 5%, more preferably no lower than 10%, particularly preferably no lower than 50%, and most preferably no lower than 80%.

If necessary, the capacitor element 10 can include an arbitrary component other than the aforementioned components.

For example, the dielectric layer 12 can include a pre-coat layer preferably having a thickness of no larger than 1 μm on the solid electrolytic layer 13 side. A public-known component can be used for the pre-coat component and examples thereof include inorganic components such as silicon, and various types of resins. As for the resin for the pre-coat layer, resins similar to those other than the organic conductive polymers that are arbitrarily included in the graphene-containing layer can be used. For the resin for the pre-coat layer, a resin including an oxygen-containing group such as a carbonyl group, a hydroxyl group, a carboxy group, and a sulfo group is preferred because it repairs the dielectric oxide film.

When the process for forming the solid electrolytic layer 13 includes a high-temperature process, an inorganic substance such as silicon or a resin having a relatively high heat resistance such as a silicone resin is preferably used as the component of the pre-coat layer.

There is no particular restriction on the method for forming the pre-coat layer. It is preferred to adopt a liquid phase method in which a series of processes including depositing a solution including a pre-coat component on the dielectric layer 12 and drying the deposited solution is carried out at least once and preferably at least twice.

As explained so far, according to this embodiment, it is possible to provide a solid electrolytic capacitor 1 whose electrolyte is less susceptible to deterioration due to a high temperature and which has a low ESR.

### EXAMPLE

Examples according to the present disclosure and comparative examples are explained hereinafter.

### Example 1

A Ta plate was prepared as an anode conductor. This Ta plate was oxidized (anode oxidation) by electrolysis at 10 V in a phosphoric acid solution and a dielectric oxide film (a dielectric layer) was thereby formed on a surface of the Ta plate. Next, as a solid electrolyte layer, a graphene-containing layer (having an oxygen content of 0%) consisting of a single-layer graphene was formed over the entire surface of the dielectric oxide film by a CVD method. Next, a silver layer was formed as a cathode extraction layer by using a commercially-available silver paste and a capacitor element was thereby obtained. Table 1 shows compositions of solid electrolyte layers, and ratios of contact areas of graphene structures to surface areas of dielectric layers.

### Example 2

A capacitor element was obtained in a manner similar to that for the Example 1, except that the graphene-containing layer (having an oxygen content of 0%) was formed by dropping an N-methyl-pyrrolidone (NMP) dispersion liquid of a single-layer graphene onto the dielectric oxide film and drying the dispersion liquid at 120° C. for 60 minutes. Table 1 shows compositions of solid electrolyte layers, and ratios of contact areas of graphene structures to surface areas of dielectric layers.

### Examples 3 to 8

Each of capacitor elements was obtained in a manner similar to that for the Example 2, except that the graphene-containing layer (having an oxygen content of 0%) was formed by using an NMP dispersion liquid of a multi-layer graphene (the number of layers is 2 to 31) instead of using the NMP dispersion liquid of the single-layer graphene. Table 1 shows compositions of solid electrolyte layers, and ratios of contact areas of graphene structures to surface areas of dielectric layers.

### Examples 9 to 11

Each of capacitor elements was obtained in a manner similar to that for the Example 2, except that the graphene-containing layer (having an oxygen content of 10 to 40%) was formed by using an NMP dispersion liquid of a modified multi-layer graphene (the number of layers is 5) instead of using the NMP dispersion liquid of the single-layer graphene. Table 1 shows compositions of solid electrolyte layers, and ratios of contact areas of graphene structures to surface areas of dielectric layers.

### Example 12

A capacitor element was obtained in a manner similar to that for the Example 9, except that the process for forming the conductive electrolyte layer was changed. Specifically, a conductive polymer layer was formed by dropping a water dispersion liquid of PEDOT/PSS (i.e., polyethylene dioxythiophene doped with polystyrene sulfonate as dopant) (Manufactured by Heraeus K. K., Trade name: Clevios (Registered Trademark) P) so as to cover 90% of the surface of the dielectric oxide film and drying the water dispersion liquid at 120° C. for 60 minutes. Next, a graphene-containing layer was formed by using an NMP dispersion liquid of a modified multi-layer graphene in a manner similar to that for Example 9 so as to cover the exposed surface part (the remaining part of 10%) of the dielectric oxide film and the above-described conductive polymer layer. In this way, the solid electrolyte layer having a laminated structure of the conductive polymer layer and the graphene-containing layer was formed. Table 1 shows compositions of solid electrolyte layers, and ratios of contact areas of graphene structures to surface areas of dielectric layers.

### Example 13

A capacitor element was obtained in a manner similar to that for the Example 12, except that the conductive polymer layer was formed so as to cover 95% of the surface of the dielectric oxide film. Table 1 shows compositions of solid electrolyte layers, and ratios of contact areas of graphene structures to surface areas of dielectric layers.

### Example 14

A capacitor element was obtained in a manner similar to that for the Example 9, except that a powder-sintered body of Ta, which was produced by a publicly-known method, was used as the anode conductor. Table 1 shows compositions of solid electrolyte layers, and ratios of contact areas of graphene structures to surface areas of dielectric layers.

### Comparative Example 1

In a manner similar to that for Example 12, a dielectric oxide film (a dielectric layer) was formed on a surface of a Ta plate and a conductive polymer layer was formed over its entire surface as a solid electrolyte layer. Next, a graphite layer and a silver layer were successively laminated on the solid electrolyte layer as the cathode extraction layer, and a capacitor element was thereby obtained. The graphite layer was formed by applying and drying a commercially-available graphite paste. The method for forming the silver layer was similar to that for Example 12. Table 1 shows compositions of solid electrolyte layers, and ratios of contact areas of graphene structures to surface areas of dielectric layers.

[Properties to be Evaluated and Evaluation Methods]

The following evaluations were made for each of Examples 1 to 14 and Comparative Example 1. Initial ESRs of the obtained capacitor elements were measured by using a commercially-available LCR meter. A defective rate of capacitor elements was evaluated by performing a voltage applying test (1.0 W.V) for the obtained capacitor element at 125° C. for 1,000 hours, and then measuring an ESR and a leak current (LC) of the capacitor element by using the same LCR meter as that used for the initial ESR. In this evaluation, ESRs that were twice as large as the initial value or larger were determined to be outside the specification. Further, leak currents of 0.1 CV (0.1×(initial capacity)×(formation voltage)) or larger were determined to be outside the specification. The number of evaluated capacitor elements was 100.

[Evaluation Result]

Table 1 shows evaluation results.

As shown in Table 1, in Examples 1 to 14 in each of which a capacitor element with a solid electrolyte layer including a graphene-containing layer was manufactured, the ESR defective rate and the LC defective rate were able to be remarkably reduced compared to those of Comparative Example 1 in which a solid electrolyte layer consisting of a conductive polymer layer alone was formed. Among them, in Examples 1 to 7 (in particular, Examples 1 to 6) in each of which a graphene structure having 1 to 30 layers (in particular, 1 to 20 layers) was used, the reducing effect for the ESR defective rate and the LC defective rate was remarkable. In Examples 9-11 and 14 in each of which a modified graphene structure was used, the reducing effect for the ESR defective rate and the LC defective rate was also remarkable. Further, it was found that the higher the ratio of the contact area of the graphene structure to the surface area of the dielectric layer was, the more remarkable the reducing effect for the ESR defective rate and the LC defective rate was.

Note that in each of Examples 1 to 14, a capacitor element in which a single plate or a powder-sintered body was used as the anode conductor was evaluated. However, a similar effect can be expected even when an etching foil or the like is used as the anode conductor.

TABLE 1

| | Solid electrolyte layer | | | Ratio of contact area of | | |
|---|---|---|---|---|---|---|
| | | Graphene-containing layer | | graphene structure to | Evaluation result | |
| | Other electrolyte | Number of layers of | | surface area of dielectric | ESR | LC |
| | layer | graphene structure | Modifying group | layer | defective rate | defective rate |
| Example 1 | — | Single layer | — | 100% | 3% | 4% |
| Example 2 | — | Single layer | — | 100% | 3% | 3% |
| Example 3 | — | 2 layers | — | 100% | 2% | 4% |
| Example 4 | — | 5 layers | — | 100% | 2% | 3% |
| Example 5 | — | 10 layers | — | 100% | 3% | 3% |
| Example 6 | — | 20 layers | — | 100% | 5% | 5% |
| Example 7 | — | 30 layers | — | 100% | 8% | 5% |
| Example 8 | — | 31 layers | — | 100% | 19% | 9% |
| Example 9 | — | 5 layers | Carbonyl group | 100% | 2% | 1% |
| Example 10 | — | 5 layers | Sulfo group | 100% | 4% | 1% |
| Example 11 | — | 5 layers | Hydroxyl group | 100% | 2% | 2% |
| Example 12 | Conductive polymer | 5 layers | Carbonyl group | 10% | 8% | 1% |
| Example 13 | Conductive polymer | 5 layers | Carbonyl group | 5% | 25% | 1% |
| Example 14 | — | 5 layers | Carbonyl group | 80% | 3% | 2% |
| Comparative | Conductive polymer | — | — | — | 95% | 10% |
| Example 1 | | | | | | |

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A solid electrolytic capacitor comprising a capacitor element comprising an anode conductor, a dielectric layer, a solid electrolytic layer, and a cathode extraction layer, the dielectric layer, the solid electrolytic layer, and the cathode extraction layer being successively formed on the anode conductor, wherein,
the solid electrolyte layer comprises a graphene-containing layer including at least one type of a graphene structure consisting of a graphene or a multi-layer graphene, and the graphene or the multi-layer graphene may include a modifying group.

2. The solid electrolytic capacitor according to claim 1, wherein the graphene structure is a graphene including a modifying group or a laminate of a graphene including a modifying group.

3. The solid electrolytic capacitor according to claim 2, wherein the modifying group is at least one type of an oxygen-containing group selected from a group consisting of a carbonyl group, a hydroxyl group, a carboxy group, and a sulfo group.

4. The solid electrolytic capacitor according to claim 1, wherein a ratio of a contact area of the graphene structure to a surface area of the dielectric layer is equal to or higher than 10%.

5. The solid electrolytic capacitor according to claim 2, wherein a ratio of a contact area of the graphene structure to a surface area of the dielectric layer is equal to or higher than 10%.

6. The solid electrolytic capacitor according to claim 1, wherein the anode conductor is a powder-sintered body.

7. The solid electrolytic capacitor according to claim 2, wherein the anode conductor is a powder-sintered body.
